(19) United States
(12) Patent Application Publication
(10) Pub. No.: US 2026/0141274 A1
(43) Pub. Date: May 21, 2026

(54) MODEL AS A SERVICE BASED ON HYBRID MIXTURE OF EXPERTS (MOE) ARCHITECTURE

(71) Applicant: International Business Machines Corporation, Armonk, NY (US)

(72) Inventors: Zhong Fang Yuan, Xi'an (CN); Tong Liu, XI'AN (CN); Wen Wang, Beijing (CN); He Li, Beijing (CN); Li Juan Gao, Xi'an (CN)

(21) Appl. No.: 18/950,008

(22) Filed: Nov. 16, 2024

(51) Int. Cl. G06N 5/043

(52) U.S. Cl. CPC G06N 5/043

(57) ABSTRACT

An example operation includes one or more of executing a plurality of machine learning (ML) models on questions to generate a plurality of outputs which include a plurality of chains of thought (COT), respectively, generating a mapping between a plurality of different types of tasks and the plurality of ML models, respectively, based on the plurality of COT, receiving a request to execute a predictive process that includes a plurality of sub-tasks, executing a software as a service (SaaS) ML model on the plurality of sub-tasks and the mapping to identify a subset of ML models from among the plurality of ML models for performing the plurality of sub-tasks, respectively, and generating a map that identifies which ML models will perform which sub-tasks, respectively, and an order in which the plurality of sub-tasks are to be executed during the predictive process.

### BACKGROUND

Large language models (LLMs) include a software-as-a-service (SaaS) model and a local model deployment. The SaaS model provides access to LLMs without the need to maintain a language model environment. However, the SaaS model also involves the risk of exposing valuable data, which may make it less appealing to entities prioritizing data security. Locally deployed language models, while better positioned for data security, lack sufficient flexibility.

### SUMMARY

One example embodiment provides a computer-implemented method that may include one or more of executing a plurality of machine learning (ML) models on questions to generate a plurality of outputs which include a plurality of chains of thought (COT), respectively, generating a mapping between a plurality of different types of tasks and the plurality of ML models, respectively, based on the plurality of COT, receiving a request to execute a predictive process that includes a plurality of sub-tasks, executing a software as a service (SaaS) ML model on the plurality of sub-tasks and the mapping to identify a subset of ML models from among the plurality of ML models for performing the plurality of sub-tasks, respectively, and generating machine-readable instructions which include a sequence among the subset of ML models for executing the plurality of sub-tasks.

Another example embodiment provides a computer system that may include a processor set, a set of one or more computer-readable storage media, and program instructions, collectively stored in the set of one or more storage media, that cause the processor set to perform computer operations that may include one or more of executing a plurality of machine learning (ML) models on questions to generate a plurality of outputs which include a plurality of chains of thought (COT), respectively, generating a mapping between a plurality of different types of tasks and the plurality of ML models, respectively, based on the plurality of COT, receiving a request to execute a predictive process that includes a plurality of sub-tasks, executing a software as a service (SaaS) ML model on the plurality of sub-tasks and the mapping to identify a subset of ML models from among the plurality of ML models for performing the plurality of sub-tasks, respectively, and generating machine-readable instructions which include a sequence among the subset of ML models for executing the plurality of sub-tasks.

A further example embodiment provides a computer program product that may include a set of one or more computer-readable storage media, and program instructions, collectively stored in the set of one or more computer-readable storage media, for causing a processor set to perform computer operations that may include one of more of executing a plurality of machine learning (ML) models on questions to generate a plurality of outputs which include a plurality of chains of thought (COT), respectively, generating a mapping between a plurality of different types of tasks and the plurality of ML models, respectively, based on the plurality of COT, receiving a request to execute a predictive process that includes a plurality of sub-tasks, executing a software as a service (SaaS) ML model on the plurality of sub-tasks and the mapping to identify a subset of ML models from among the plurality of ML models for performing the plurality of sub-tasks, respectively, and generating machine-readable instructions which include a sequence among the subset of ML models for executing the plurality of sub-tasks.

### BRIEF DESCRIPTION OF THE DRAWINGS

FIG. 1 is a diagram illustrating a computing environment according to an embodiment of the instant solution.

FIG. 2 is a diagram illustrating a model service with a hybrid mixture of experts (MOE) architecture according to the examples and features of the instant solution.

FIG. 3A is a diagram illustrating a process of generating chains of thought from expert ML models according to examples and features of the instant solution.

FIG. 3B is a diagram illustrating a process of mapping tasks to expert ML models according to examples and features of the instant solution.

FIG. 3C is a diagram illustrating a process of splitting a predictive task into sub-tasks and assigning the sub-tasks to a subset of expert ML models according to the examples and features of the instant solution.

FIG. 3D is a diagram illustrating a process of generating executable instructions for the predictive task according to the examples and features of the instant solution.

FIG. 4A illustrates a flow diagram, according to example embodiments.

FIG. 4B illustrates a flow diagram, according to example embodiments.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

According to an aspect of the example embodiments, there is provided a computer-implemented method that includes executing a plurality of machine learning (ML) models on questions to generate a plurality of outputs which include a plurality of chains of thought (COT), respectively, generating a mapping between a plurality of different types of tasks and the plurality of ML models, respectively, based on the plurality of chains of thought, receiving a request to execute a predictive process that includes a plurality of sub-tasks, executing a software as a service (SaaS) ML model on the plurality of sub-tasks and the mapping in order to identify a subset of ML models from among the plurality of ML models for performing the plurality of sub-tasks, respectively, and generating machine-readable instructions which include a sequence within the subset of ML models for executing the plurality of sub-tasks. A technical advantage of the method is that both large-scale SaaS models can be used in conjunction with smaller-sized local ML models to leverage the advantages of each of the different types of ML models.

In some embodiments, the computer-implemented method may further include executing the subset of ML models on input data associated with the predictive process based on the machine-readable instructions to generate a prediction and displaying the prediction via a graphical user interface (GUI) of a software application. The technical effect of this feature is using the instructions to generate a prediction that leverages the advantages of both a SaaS ML model and a local ML model.

In some embodiments, the computer-implemented method may include executing a second ML model on an output of a first ML model, wherein the executing the second ML model comprises modifying the output of the first ML model based on a prompt template associated with model capabilities of the second ML model before executing the second ML model on the output. The technical effect of this feature is that the execution of the second ML model is ensured by converting the input data into a format that is compatible with the capabilities of the second ML model.

In some embodiments, the computer-implemented method may include identifying an ML model from among the plurality of ML models that is best-suited for a respective type of task based on a chain of thought of the ML model and a ground truth associated with an output of the ML model. The technical effect of this feature is that tasks are assigned to only the best model capable of performing the task.

In some embodiments, the computer-implemented method may include generating a data flow within the subset of ML models for executing the plurality of sub-tasks. The technical effect of this feature is that the machine-readable instructions include ordering amongst the subset of ML models ensuring efficient execution during runtime.

In some embodiments, the computer-implemented method may include generating a plurality of nodes representing the subset of ML models, and edges between the plurality of nodes representing a flow of data between the subset of ML models. The technical effect of this feature is using a graph model to represent the executable instructions thereby enabling a graph model execution of the system.

In some embodiments, the SaaS ML model and the plurality of ML models comprise a mixture of experts (MOE) architecture in which the SaaS ML model is a starting point, and the plurality of ML models are executed subsequently. The technical advantage of this feature is to build a hybrid MOE architecture that combines large models and small models, leveraging the global analysis capabilities of a large model (e.g., a SaaS model) and the task-specific efficiency of a smaller model.

According to an aspect of the example embodiments, there is provided a computer system that includes a processor set, a set of one or more computer-readable storage media, and program instructions, collectively stored in the set of one or more storage media, for causing the processor set to perform operations that include executing a plurality of machine learning (ML) models on questions to generate a plurality of outputs which include a plurality of chains of thought (COT), respectively, generating a mapping between a plurality of different types of tasks and the plurality of ML models, respectively, based on the plurality of chains of thought, receiving a request to execute a predictive process that includes a plurality of sub-tasks, executing a software as a service (SaaS) ML model on the plurality of sub-tasks and the mapping to identify a subset of ML models from among the plurality of ML models for performing the plurality of sub-tasks, respectively, and generating machine-readable instructions which include a sequence among the subset of ML models for executing the plurality of sub-tasks. A technical advantage of the method is that both large-scale SaaS models can be used in conjunction with smaller-sized local ML models to leverage the advantages of each of the different types of ML models.

In some embodiments, the processor set may perform operations that include executing the subset of ML models on input data associated with the predictive process based on the machine-readable instructions to generate a prediction and displaying the prediction via a graphical user interface (GUI) of a software application. The technical effect of this feature is using the instructions to generate a prediction that leverages the advantages of both a SaaS model and a local ML model.

In some embodiments, the processor set may perform executing a second ML model on an output of a first ML model, wherein the executing the second ML model comprises modifying the output of the first ML model based on a prompt template associated with model capabilities of the second ML model before executing the second ML model on the output. The technical effect of this feature is that the execution of the second ML model is ensured by converting the input data into a format that is compatible with the capabilities of the second ML model.

In some embodiments, the processor set may perform identifying an ML model from among the plurality of ML models that is best suited for a respective task based on a chain of thought of the ML model and a ground truth associated with an output of the ML model. The technical effect of this feature is that tasks are assigned to only the best model capable of performing the task.

In some embodiments, the processor set may perform generating a data flow within the subset of ML models for executing the plurality of sub-tasks. The technical effect of this feature is that the machine-readable instructions include ordering amongst the subset of ML models ensuring efficient execution during runtime.

In some embodiments, the processor set may perform generating a plurality of nodes representing the subset of ML models, and edges between the plurality of nodes representing a flow of data between the subset of ML models. The technical effect of this feature is using a graph model to represent the executable instructions thereby enabling a graph model execution of the system.

In some embodiments, the SaaS ML model and the plurality of ML models comprise a mixture of experts (MOE) architecture in which the SaaS ML model is a starting point, and the plurality of ML models are executed subsequently. The technical advantage of this feature is using a combination of large models and small models to build a hybrid MOE architecture that can leverage the benefits of both the large model (e.g., a SaaS model) which can perform more global analysis and a smaller-sized model which can perform better at a specific task.

According to an aspect of the example embodiments, there is provided a computer program product that includes a set of one or more computer-readable storage media, and program instructions, collectively stored in the set of one or more computer-readable storage media, for causing a processor set to perform computer operations that include executing a plurality of machine learning (ML) models on questions to generate a plurality of outputs which include a plurality of chains of thought (COT), respectively, generating a mapping between a plurality of different types of tasks and the plurality of ML models, respectively, based on the plurality of chains of thought, receiving a request to execute a predictive process that includes a plurality of sub-tasks, executing a software as a service (SaaS) ML model on the plurality of sub-tasks and the mapping to identify a subset of ML models from among the plurality of ML models for performing the plurality of sub-tasks, respectively, and generating machine-readable instructions which include a sequence among the subset of ML models for executing the plurality of sub-tasks. A technical advantage of the method is that both large-scale SaaS models can be used in conjunction with smaller-sized local ML models to leverage the advantages of each of the different types of ML models.

In some embodiments, the computer operations may further include executing the subset of ML models on input data associated with the predictive process, based on the machine-readable instructions, to generate a prediction and displaying the prediction via a graphical user interface (GUI) of a software application. The technical effect of this feature is using the instructions to generate a prediction that leverages the advantages of both a comprehensive ML model such as a SaaS model and a local ML model.

In some embodiments, the computer operations may include executing a second ML model on an output of a first ML model, wherein the executing the second ML model comprises modifying the output of the first ML model based on a prompt template associated with model capabilities of the second ML model before executing the second ML model on the output. The technical effect of this feature is that the execution of the second ML model is ensured by converting the input data into a format that is compatible with the capabilities of the second ML model.

In some embodiments, the computer operations may include identifying an ML model from among the plurality of ML models that is best suited for a respective type of task based on a chain of thought of the ML model and a ground truth associated with an output of the ML model. The technical effect of this feature is that tasks are assigned to only the best model capable of performing the task.

In some embodiments, the computer operations may include generating a data flow among the subset of ML models for executing the plurality of sub-tasks. The technical effect of this feature is that the machine-readable instructions include ordering amongst the subset of ML models ensuring efficient execution during runtime.

In some embodiments, the computer operations may include generating a plurality of nodes representing the subset of ML models, and edges between the plurality of nodes representing a flow of data between the subset of ML models. The technical effect of this feature is using a graph model to represent the executable instructions thereby enabling a graph model execution of the system.

In some embodiments, the SaaS ML model and the plurality of ML models comprise a mixture of experts (MOE) architecture in which the SaaS ML model is a starting point, and the plurality of ML models are executed subsequently. The technical advantage of this feature is using a combination of large models and small models to build a hybrid MOE architecture that can leverage the benefits of both the large model (e.g., a SaaS model) which can perform more global analysis and a smaller-sized model which can perform better at a specific task.

The system described herein may be hosted within a software application, a service, or the like, which may be hosted by a host platform such as a cloud platform, a web server, a database, or the like.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

The example embodiments are directed to a system that provides a machine learning service that includes a data-secure Model-as-a-Service (MaaS) that utilizes a hybrid Mixture of Experts (MoE) architecture. This method utilizes a mixed orchestration approach to combine the benefits of both local LLM and SaaS models, ensuring data security while providing advanced capabilities. According to various embodiments, the hybrid MoE refers to a combination of local small models and large SaaS models. It routes tasks between the models based on their capabilities, where the SaaS model(s) performs complex thought processes, and the local models perform secure task-specific executions.

In this system, the SaaS model may refer to a comprehensive or large-scale ML model that performs a comprehensive/global task analysis. This may include dividing a predictive task into smaller sub-tasks that can be assigned to specific local models, also referred to herein as “expert” models in the hybrid MOE architecture. Some of the benefits of the architecture of the system described herein, include improving data security, computational efficiency, and performance by using a hybrid MOE architecture that combines the strengths of local ML models with larger-scale SaaS models.

In some embodiments, the system of models may be integrated into a service, also referred to herein as a Model-as-a-Service (Maas). The MaaS refers to providing access to models, for example large language models (LLMs), via a cloud-based infrastructure, where users can perform various tasks using the model's capabilities without the need to host the model locally. This allows companies to use advanced models while maintaining security. The use of both local models and larger scale models introduces an innovative approach to balancing deep thinking and practical execution through a collaboration between the SaaS models and local models, enhancing both performance and security.

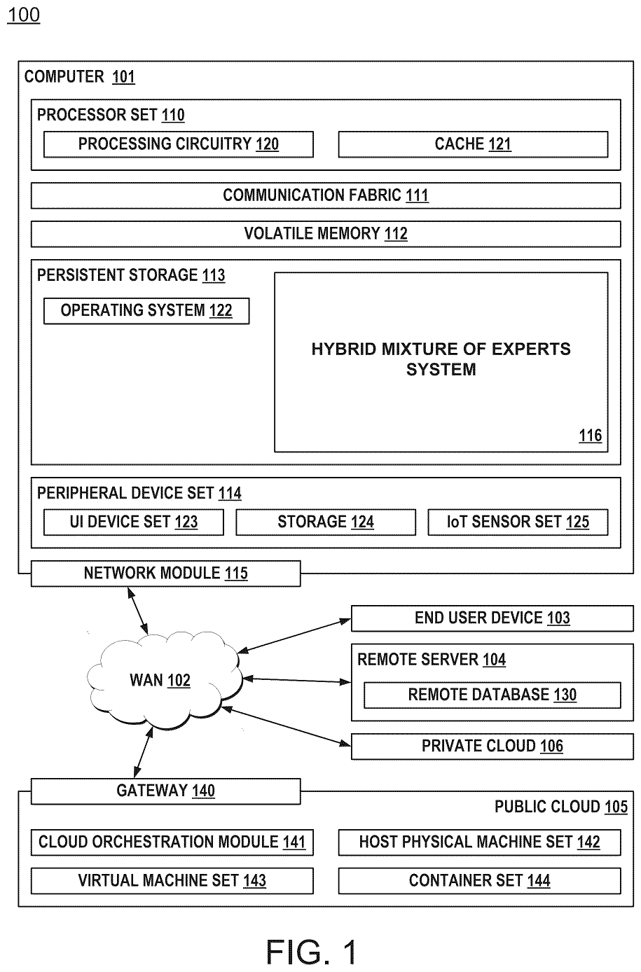

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as a hybrid mixture of experts system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud Computing Services And/or Microservices (not Separately Shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Presently, the process for generating business requirements relies heavily on manual communication and validation amongst users. Despite the rise of Large Language Models (LLMs), which has facilitated a more automated approach, the requirements often lack the granularity necessary within specific domains. These requirements tend to be generalized and face difficulty in precisely addressing the needs of a system or project. Even with the potential for automation, there remains a gap in achieving the level of specificity required for comprehensive business requirements. The generated requirements may be broad and struggle to precisely cover the diverse and nuanced needs of the system. It often necessitates extensive rounds of dialogue to cover a complete and accurate set of requirements.

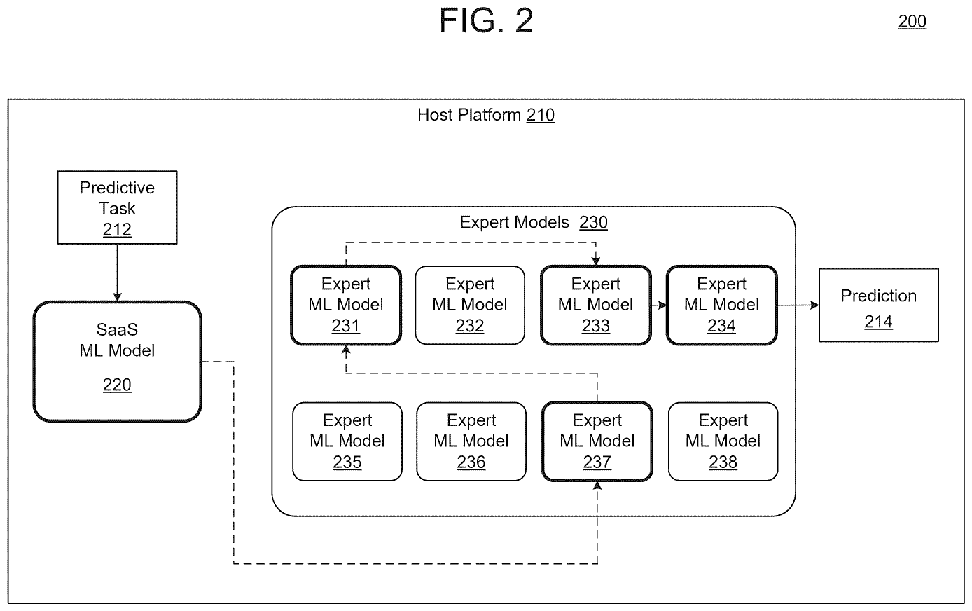

FIG. 2 shows a view 200 of a model service with a hybrid mixture of experts (MOE) architecture according to the examples and features of the instant solution. Referring to FIG. 2, the model service is implemented as a collection of models that are hosted by a host platform 210. For example, the host platform 210 may refer to a cloud platform, a web server, an on-premises server, a distributed system of nodes, and the like.

In the example of FIG. 2, the host platform 210 hosts a SaaS ML model 220 that is referred to herein as a “comprehensive” or “global” ML model configured for determining a road map for executing different types of predictive tasks. In some embodiments, the host platform 210 may host multiple SaaS ML models, though only one is shown here for simplicity. The host platform 210 also hosts a group of expert ML models 230 that are configured for more specific tasks. The group of expert ML models 230 includes an expert ML model 231, an expert ML model 232, an expert ML model 233, an expert ML model 234, an expert ML model 235, an expert ML model 236, an expert ML model 237, and an expert ML model 238. In this example, the SaaS ML model 220 is configured to identify a subset of expert ML models for carrying out a predictive task based on sub-tasks included in the predictive task.

Here, the SaaS ML model 220 receives a predictive task 212, such as a request to infer an output from input data. According to various embodiments, the SaaS ML model 220 may divide the predictive task 212 into sub-tasks, and identify which expert ML model in the group of expert ML models 230 is best-suited to perform each task, and an order in which the subset of expert ML models should be executed. In this example, the SaaS ML model 220 identifies for sub-tasks, and four expert ML models (e.g., expert ML model 237, expert ML model 231, expert ML model 233, and expert ML model 234) for carrying out the predictive task 212. Additionally, the SaaS ML model 220 also identifies an execution order (e.g., a data flow) between the subset of expert ML models for carrying out the predictive task 212. During execution, the SaaS ML model 220 divides the predictive task 212 into sub-tasks, and controls execution of the sub-tasks through the expert ML model 237, the expert ML model 231, the expert ML model 233, and the expert ML model 234, to generate a prediction 214.

The model service shown in FIG. 2 is a data-secure MaaS model service that can use control gates to control the flow of data between different expert models in a Hybrid Mixture of Experts (MoE) model architecture. This approach effectively balances the advantages and disadvantages of the SaaS ML models and local ML models, maximizing the performance of large language models while ensuring the highest level of data security. MOE is a neural network architecture that integrates expert/model layers into Transformer blocks. When data flows through the MoE layer, each input token is dynamically routed to a subset of experts for computation. This method allows for higher computational efficiency while achieving better results, as each expert specializes in handling specific tasks.

When constructing the hybrid MoE model architecture, the system described herein may establish a chain of thought (CoT) profile for each expert ML model. This is done to evaluate the performance and capabilities of each expert model. The CoT profile aims to quantify the model's performance in complex thinking, multi-layered thinking, and other aspects, providing an effective basis for the subsequent selection and combination of models in the hybrid model.

The system may also perform task decomposition and organization based on the chain of thought profiles for the expert ML models. During this step, the service leverages the deep thinking of the large SaaS ML model to generate a thought architecture roadmap based on requirements (questions) which may include user requirements. This roadmap is considered as a global task plan and is mapped to the specific thought patterns of the smaller expert ML models. The advantage is fully utilizing the thinking strengths of both large and small ML models, achieving a globally optimal solution, and enhancing data security by executing tasks through local small models. This effectively balances deep thinking and practical execution, improving the overall task-solving performance.

The system may also perform thought pattern modification during task execution. In this step, the service may enhance its effectiveness by generating preferred prompt templates for each node (expert ML model) during the roadmap creation by the larger SaaS ML model. This ensures a more friendly and efficient interaction for local small models during task execution and can also improve system performance. Additionally, template generation helps reduce inconsistencies and conflicts in model integration, maintaining consistency across different nodes and enhancing the stability and accuracy of task execution. The introduction of prompt templates effectively strengthens the collaboration between large and small models, improving the synergy in the task chain and providing robust support for achieving optimal results.

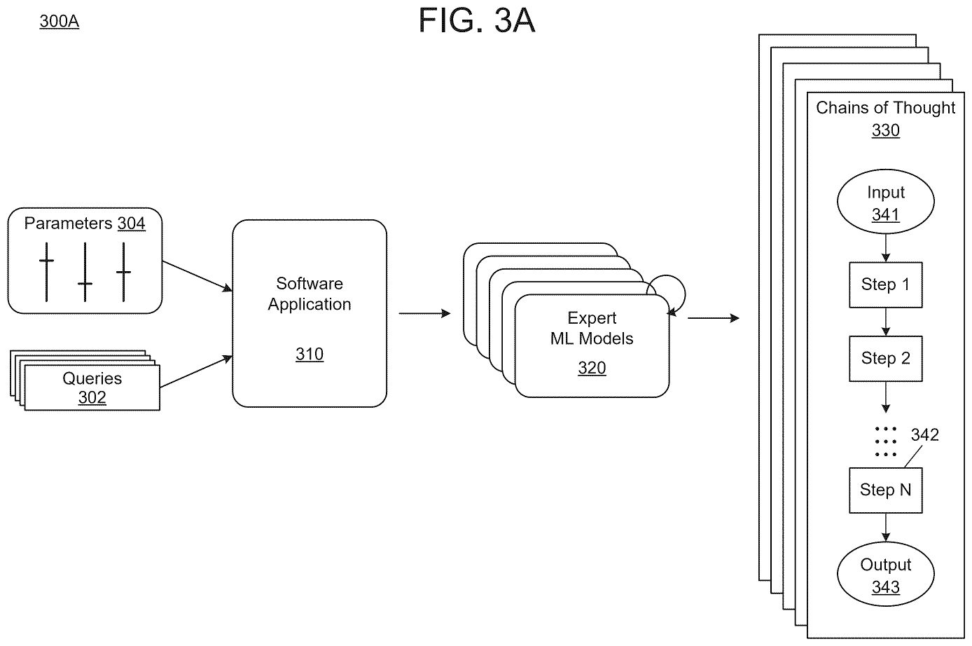

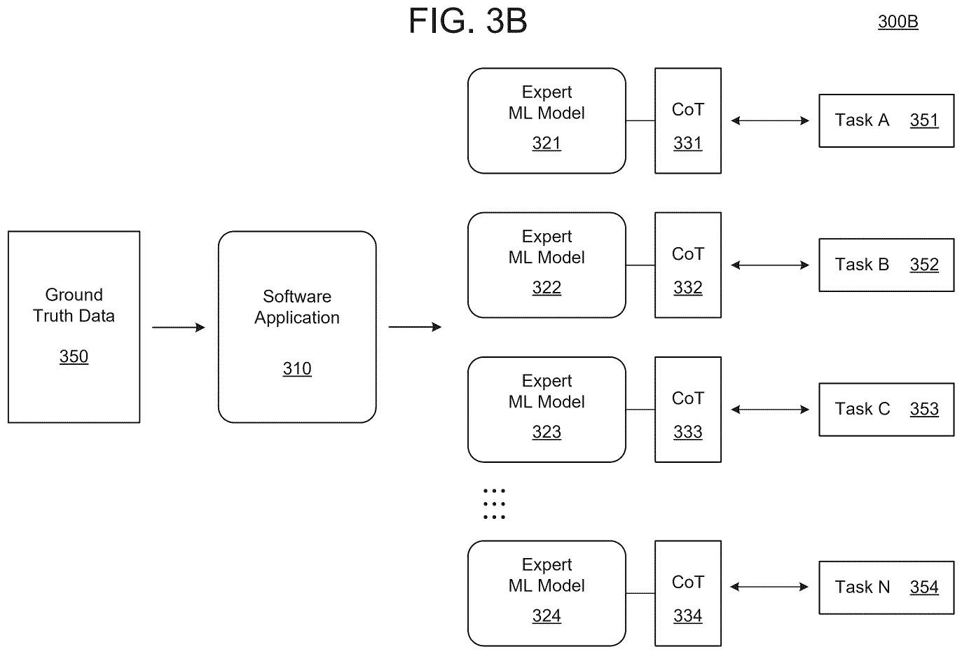

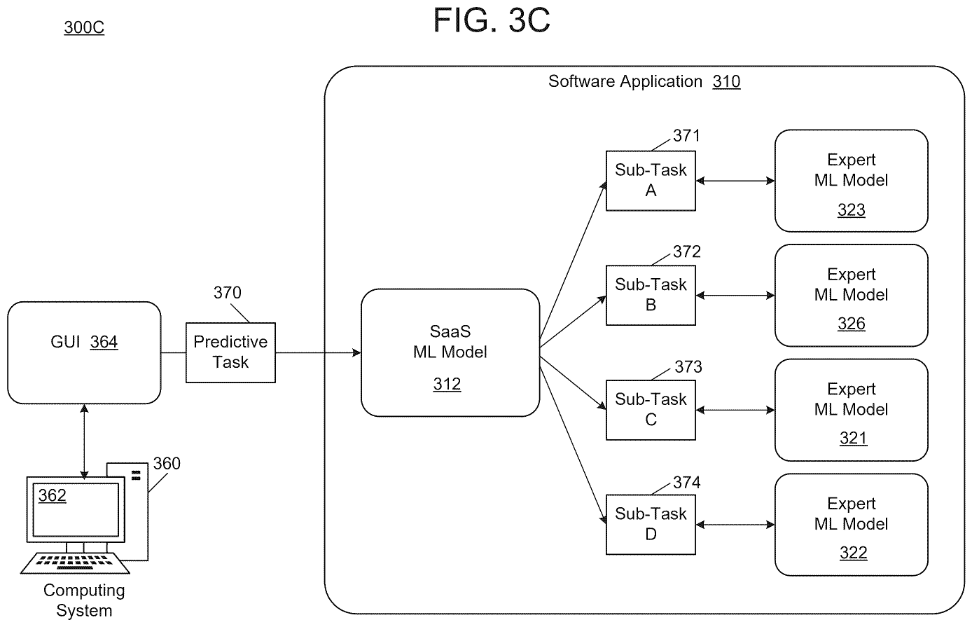

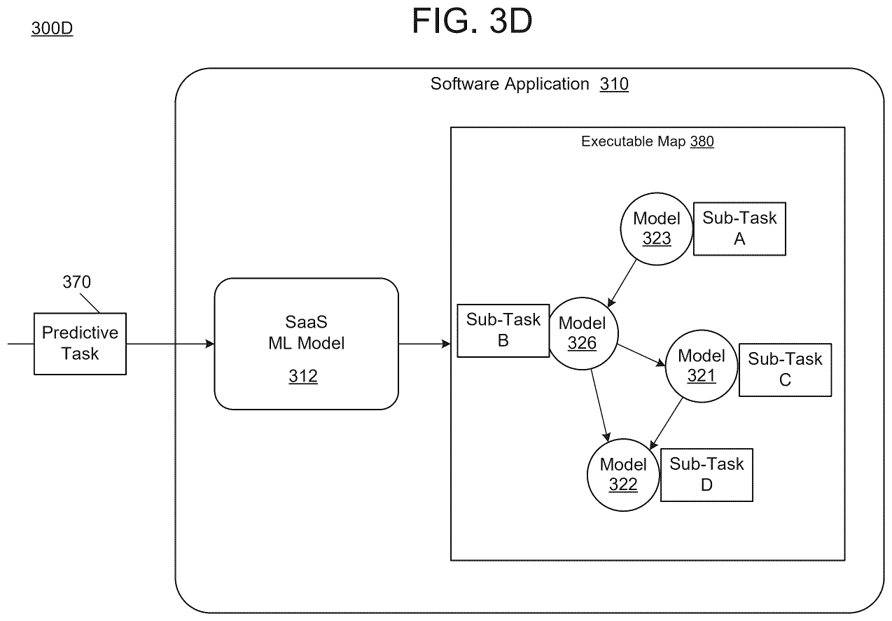

FIG. 3A illustrates a process 300A of generating chains of thought from expert ML models according to examples and features of the instant solution. Referring to FIG. 3A, a software application 310 may host the MoE model service described herein, such as the example shown in FIG. 2. In this example, the software application 310 may evaluate a group of expert ML models 320, for example, the expert ML models 230 shown in FIG. 2. In this example, the software application 310 may submit inputs to the expert ML models 320 to identify chains of thought 330 of the expert ML models 320. The inputs may include open-ended questions designed to draw out thought patterns of the expert ML models 320. For example, the open-ended questions may include queries 302 and parameters 304 which may be dynamically set/adjusted by the software application 310.

In response to receiving the inputs, each expert ML model may generate its own chain of thought 330 which include an identifier of an input 341, an identifier of an output 343, and intermediate steps 342 (e.g., thoughts, etc.) performed by the expert ML model to convert the input 341 to the output 343. Here, the software application 310 may prepare a large number of open-ended questions (no need for annotation, with a quantity that meets statistical significance). The software application 310 may combine these questions with prompt templates that can generate a Chain of Thought, paired with different randomly generated parameters 304 (e.g., temperature, top-k, top-n, etc.) input into various expert ML models. This aims to obtain the thought chain outputs of different expert ML models for these questions under varying creativity levels. These outputs can be viewed as the thought processes (thinking steps) adopted by different LLMs when solving different problems. Generally, under different parameter combinations, the outputs of large models (including final answers and CoT) may not be identical. The output of this step is a new dataset composed of [question, thought chain set, model type]. After obtaining this dataset, the software application 310 may employ frequent pattern mining to identify several thought methods most commonly used by the different expert ML models.

That is, the unsupervised mining identifies chain of thought patterns, which reflect how LLMs think or solve problems. This involves sending open-ended questions to the models and analyzing their responses. The LLMs used in this step are expert ML models, which specialize in specific tasks or types of thinking. These models can be large SaaS models or smaller local models, depending on the task. The open-ended questions are designed to assess the model's thinking process by prompting it to generate a chain of thought for each task. These questions don't require predefined answers, allowing the model to explore various reasoning paths. These questions are pre-defined but can vary dynamically by modifying parameters such as temperature or creativity settings, allowing the model to explore different thought patterns.

FIG. 3B illustrates a process 300B of mapping tasks to expert ML models according to examples and features of the instant solution. Referring to FIG. 3B, the software application 310 may use ground truth data 350 to determine whether the outputs generated by the expert ML modes are accurate or inaccurate (e.g., introduced errors, etc.). The models which perform well (e.g., which are accurate, or somewhat accurate) may be labeled as positive, while the models which do not perform well, or introduce errors, may be labelled as negative. Furthermore, the software application 310 may evaluate multiple different tasks this same way. Accordingly, the software application 310 may use this process to figure out which expert ML model is best at which different task among the different possible predictive tasks.

In the example of FIG. 3B, the software application 310 determines that expert ML model 321 is best suited for a task 351, based on a chain of thought 331 of the expert ML model 321. Likewise, the software application 310 determines that expert ML model 322 is best-suited for a task 352, based on a chain of thought 332 of the expert ML model 322, the software application 310 determines that expert ML model 323 is best-suited for a task 353, based on a chain of thought 333 of the expert ML model 323, and the software application 310 determines that expert ML model 324 is best-suited for a task 354, based on a chain of thought 334 of the expert ML model 324. Here, the tasks refer to predictive tasks. Examples of predictive tasks include answering questions, inputting missing data, asking questions/queries, classifying input data into categories, and the like.

In some embodiments, the chain of thought may be used to construct a “thought profile.” The thought profile based on CoT refers to an evaluation criterion that assesses the deep-thinking ability of the expert ML model represented by thought chains. This evaluation criterion differs from conventional approaches that use large-scale test datasets to calculate accuracy, F1 score, recall, and other testing metrics and use them as evaluation factors. Instead, it focuses on assessing whether the thought process is correct, providing a measurement of the model's ability from a “meta perspective” and a “fundamental perspective.”

It can determine which type of thinking a model is more suitable for a particular predictive task, such as Model A excelling in deductive reasoning and Model B excelling in inductive counter reasoning, etc. This evaluation method breaks away from the confines of using a fixed dataset to validate and bind model capabilities, presenting a novel evaluation approach that forms the data foundation of the service.

The chains of thought obtained summarized several thought methods most commonly used by different models. These thought methods are usually limited in scope and can be easily exhaustively listed. Therefore, these thought methods can be annotated at a relatively small cost. Building on the previous step, the software application 310 may perform a binary annotation (Positive or Negative) for the commonly used thought methods of the models. This annotation method allows the software application 310 to determine within the framework of supervised learning whether the commonly used thought methods of the model have a positive or negative impact on ultimately solving problems.

In the end, the software application 310 may create a “Thought Profile” for each model, which can be divided into three dimensions including thought methods commonly used by the model with positive effects. This occurs when the model adopts these methods, and it has a positive impact on the final problem-solving. These thought methods are generally considered effective, reliable, and helpful in improving model performance. In a second dimension, thought methods used by the model can have negative effects. When the model adopts these methods, it may have adverse or negative effects on the final problem-solving. These thought methods may lead to a decrease in performance or instability in certain aspects of the model. In a third dimension, the thought methods are not commonly used by the model. This includes some relatively less adopted or explored thinking or processing methods. These methods may not be widely adopted due to novelty, complexity, or limited research.

The purpose is to evaluate the thinking process of different models and determine which expert model is best suited for specific types of tasks based on their CoT profile. The software application may annotate commonly used thought methods in the models, classifying them as positive or negative based on their effectiveness in solving tasks. A positive impact means the thought process improved performance, while a negative one hindered it. The output is a thought profile for each model, detailing its commonly used thought methods and classifying them as positive, negative, or rarely used. Furthermore, a mapping may be generated which maps predictive tasks to a particular expert ML model based on the chains of thought / though profiles.

FIG. 3C illustrates a process 300C of splitting a predictive task into sub-tasks and assigning the sub-tasks to a subset of expert ML models according to the examples and features of the instant solution. Referring to FIG. 3C, the software application 310 may provide a graphical user interface (GUI) 364 that can be accessed by a computing system 360 and displayed on a display device 362 of the computing system 360. Here, the computing system 360 may access the software application 310 through a browser installed on the computing system 360. For example, the software application 310 may be a progressive web application, or the like, which can be accessed on the Internet.

During operation, a user may input a predictive task 370 into the GUI 364, and submit the predictive task 370 to the software application 310. In response, a SaaS ML model 312 may receive the predictive task 370 and identify a plurality of sub-tasks that are included within the predictive task 370. Sub-tasks may include smaller tasks extracted from larger predictive tasks. For example, sub-tasks may include data preprocessing which includes cleaning and formatting input data to prepare it for further analysis. Sub-tasks may include feature extract which includes extracting key features from the data to help models better understand the main content. Sub-tasks may include classification or grouping which includes categorizing data based on specific criteria to allow more focused processing of different categories. Sub-tasks may include predicting specific attributes, for example, predicting purchase intent based on user behavior data. Sub-tasks include result integration which includes aggregating and consolidating outputs from multiple models to form the final prediction result.

According to various embodiments, the SaaS ML model 312 identifies sub-tasks 371, 372, 373, and 374 which are different in type. Furthermore, the SaaS ML model 312 also identifies which expert ML models from the group of expert ML models 320 are best suited for each of the sub-tasks 371, 372, 373, and 374. In this example, the SaaS ML model 312 assigns the sub-task 371 to expert ML model 323, assigns the sub-task 372 to expert ML model 326, assigns the sub-tasks 373 to expert ML model 321, and assigns the sub-task 374 to expert ML model 322. In addition, the SaaS ML model 312 also identifies an order of execution which includes the expert ML model 323, followed by the expert ML model 326, followed by the expert ML model 321, and finally the expert ML model 322.

FIG. 3D illustrates a process 300D of generating executable instructions for the predictive task 370 based on the assignments generated in the process 300C of FIG. 3C, according to the examples and features of the instant solution. Referring to FIG. 3D, the software application 310 may convert the assigned sub-tasks into an executable map 380 which identifies which expert ML models execute which sub-tasks, and an ordering among the execution of the expert ML models. The executable map 380 also includes a data flow that shows how the outputs and the inputs of the expert ML models should be connected to one another. In this example, the output of the expert ML model 323 should be input to the expert ML model 326 and to the expert ML model 321. Meanwhile, the output of the expert ML model 326 should be input to the expert ML model 322. Likewise, the output of the expert ML model 321 should also be input to the expert ML model 322. The executable map also identifies which sub-tasks of the predictive task should be executed by each expert ML model.

According to various embodiments, the executable map 380 may include executable instructions that are machine-readable and capable of interpretation by a hardware processor of a computer system such as a cloud platform. In this example, the executable map 380 may include a structured task execution framework used to manage the collaboration of various machine learning models within the hybrid MoE architecture. For example, the roadmap may include a set of machine-readable instructions represented as a graph model.

The graph model may include executable instructions on how each model should sequentially execute its assigned sub-tasks. These instructions are machine-readable, making them easy for the system to understand and carry out. The graph model is also referred to as a roadmap and may be represented as a graph, where nodes represent different expert models, and edges represent the data flow between models. This graph model visually demonstrates task allocation and execution order. Each node also includes customized input templates which identify the format of data expected by each of the models to ensure smooth data transfer between models, reducing errors. The main purpose of the roadmap is to break down complex predictive tasks into multiple sub-tasks and coordinate the execution sequence of each model. It enhances efficiency and data security by ensuring tasks are processed on the appropriate models.

The roadmap consists of a sequence of steps, where each step represents a task or sub-task. Each node in the roadmap corresponds to a model that is specialized in a thought process for solving that part of the task. The nodes represent specific sub-tasks or steps in the roadmap where decisions or predictions are made by local or SaaS models. The edges between the nodes represent the flow of data or decisions from one node to another, showing how the output of one model influences the next step.

According to various embodiments, the system described herein may obtain thought profiles of local small models. Typically, due to cost considerations, local small models often adopt smaller model sizes, such as 7B or 13B, limiting their deep thinking and planning capabilities, in comparison to larger-sized SaaS models that are hosted on a cloud platform or other remote server. To more effectively leverage these local small models, the service described herein can utilize the deep-thinking capabilities provided by the large-scale SaaS models running on the SaaS side to identify which local models are better for which sub-tasks. In this approach, the large SaaS model is a starting point for tasks, leveraging their outstanding thinking abilities to generate a thought architecture roadmap. This roadmap can be seen as a global plan for a task, where each key node can be mapped to the specific thought patterns that local small models excel in. The actual task execution is then handled by the local small models.

This approach has multiple advantages. Firstly, from a global perspective, the service can fully leverage the thinking strengths of both large and small models, approaching a global optimal solution at the level of solving specific tasks. The deep-thinking ability of the large model provides high-level guidance for the overall process, while the small models showcase their expertise in local tasks. Secondly, by having local small models perform actual tasks, the service can achieve a significant improvement in data security. Since the large SaaS model on the SaaS side does not need to access any real or sensitive data, it virtually eliminates the risks of data leaks and privacy concerns. This collaborative model architecture not only contributes to the efficiency of task execution but also provides additional safeguards for data security. Overall, by establishing an effective collaboration between large SaaS models and local small models, the service can better balance the relationship between deep thinking and practical execution, achieving superior overall performance in the process of task resolution.

While there is reference to “local” models herein, it should be appreciated that both the SaaS ML model(s) and the expert ML model(s) may be hosted on a cloud platform. That is, the service itself may run entirely on the cloud platform.

Furthermore, according to various embodiments, when the large SaaS ML model generates the roadmap, the service may not only consider it as the global plan for tasks but also generate an additional prompt template for the input of each expert ML model (node). The generation process of this template is based on the thought profiles of various local small models, especially their commonly used thought patterns that can produce positive effects. This way, the service can create a template for each node / expert ML model that aligns more closely with the thinking characteristics of the expert ML model.

The advantage of this additional step is that it ensures a more friendly and efficient interaction among various local small models during task execution. Since the input for each node has been adjusted to fit the preferences of local small models, downstream models find it easier to understand and adapt to the output from upstream models. The introduction of such templates essentially encourages smoother collaboration between different models, thereby improving the overall system performance. Moreover, the template generation process also helps reduce potential inconsistencies and conflicts during the model integration process. By mimicking the commonly used thought patterns of each local small model, the service can better maintain the overall consistency of the system across different nodes, enhancing the stability and accuracy of the overall task execution. In summary, by introducing prompt templates that mimic the thinking patterns of local small models during the thought architecture roadmap generation process, the service can not only strengthen the collaboration between large and small models but also effectively enhance the synergistic effects of the entire system in the task chain, providing robust support for achieving optimal results.

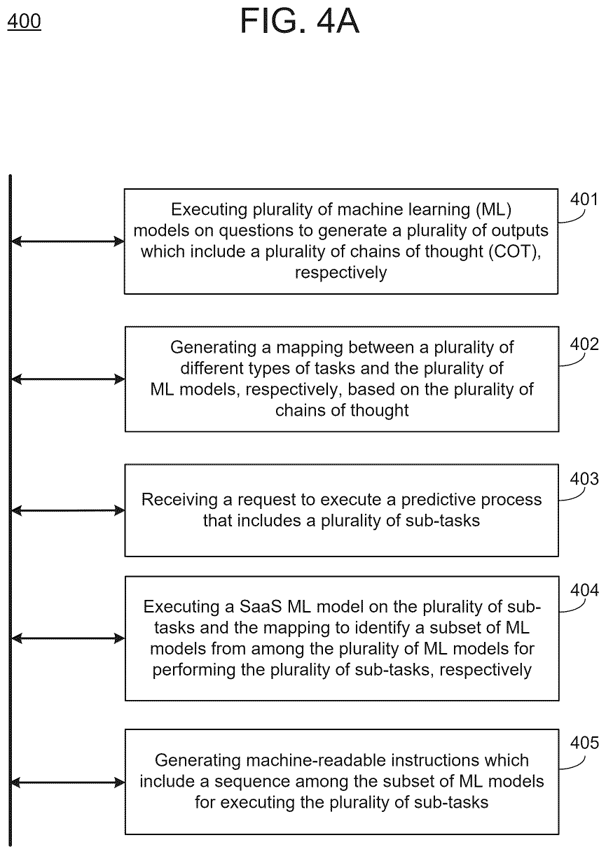

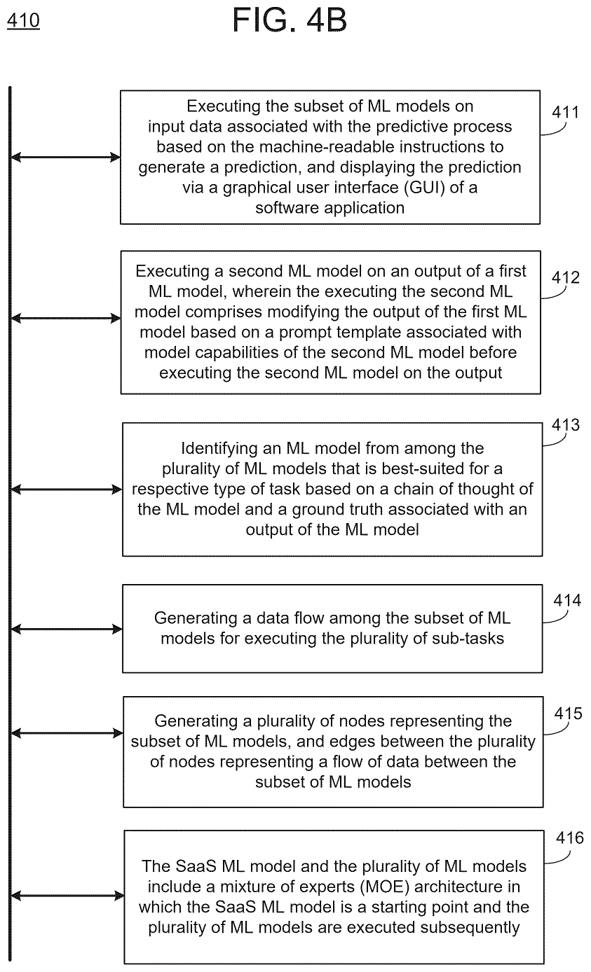

FIG. 4A illustrates a flow diagram of a method 400, according to example embodiments. Referring to FIG. 4A, the method 400 may include executing a plurality of machine learning (ML) models on questions to generate a plurality of outputs which include a plurality of chains of thought (COT), respectively, in 401. In 402, the method may include generating a mapping between a plurality of different types of tasks and the plurality of ML models, respectively, based on the plurality of chains of thought. In 403, the method may include receiving a request to execute a predictive process that includes a plurality of sub-tasks. In 404, the method may include executing a SaaS ML model on the plurality of sub-tasks and the mapping to identify a subset of ML models from among the plurality of ML models for performing the plurality of sub-tasks, respectively. In 405, the method may include generating machine-readable instructions which include a sequence among the subset of ML models for executing the plurality of sub-tasks.

FIG. 4B illustrates a flow diagram of a method 410, according to example embodiments. Referring to FIG. 4B, in 411, the method may include executing the subset of ML models on input data associated with the predictive process based on the machine-readable instructions to generate a prediction, and displaying the prediction via GUI of a software application. In 412, the executing the subset of ML models may include executing a second ML model on an output of a first ML model, and the executing the second ML model may include modifying the output of the first ML model based on a prompt template associated with model capabilities of the second ML model before executing the second ML model on the output. In 413, the generating the mapping may include identifying an ML model from among the plurality of ML models that is best suited for a respective type of task based on a chain of thought of the ML model and a ground truth associated with an output of the ML model.

In 414, the generating the machine-readable instructions may include generating a data flow among the subset of ML models for executing the plurality of sub-tasks. In 415, the generating may include generating a plurality of nodes representing the subset of ML models, and edges between the plurality of nodes representing a flow of data between the subset of ML models. In 416, the SaaS ML model and the plurality of ML models may include a mixture of experts (MOE) architecture in which the SaaS ML model is a starting point, and the plurality of ML models are executed subsequently.

Detailed descriptions of training a machine learning model and executing a machine learning model are further described and depicted herein.

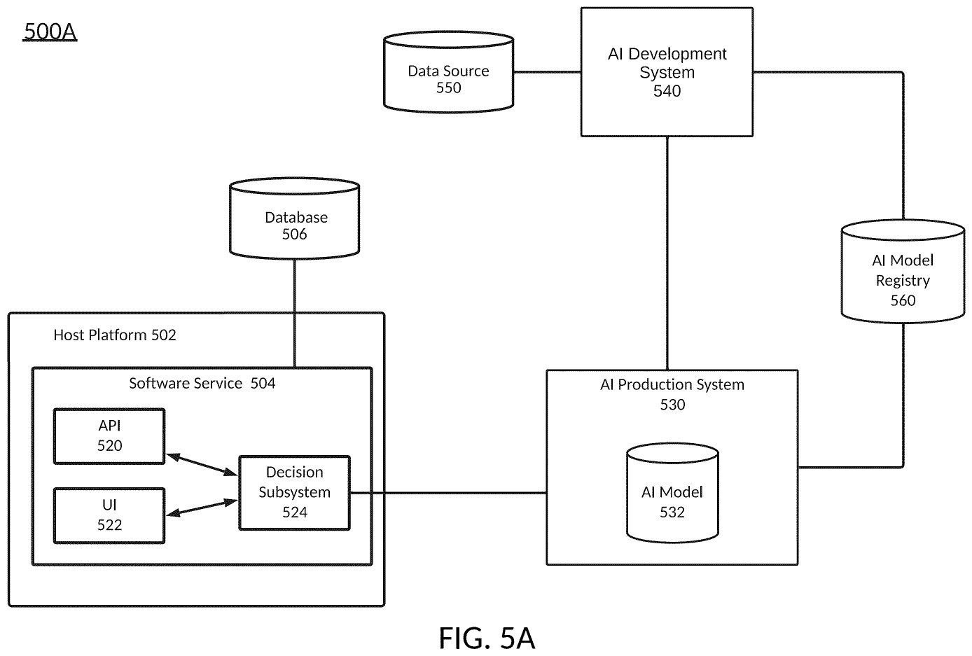

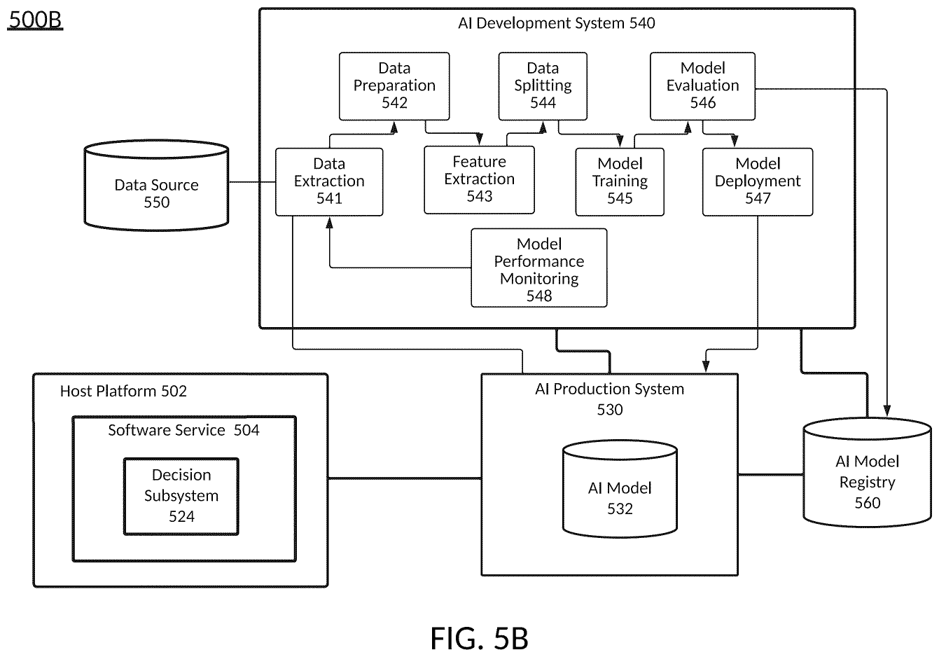

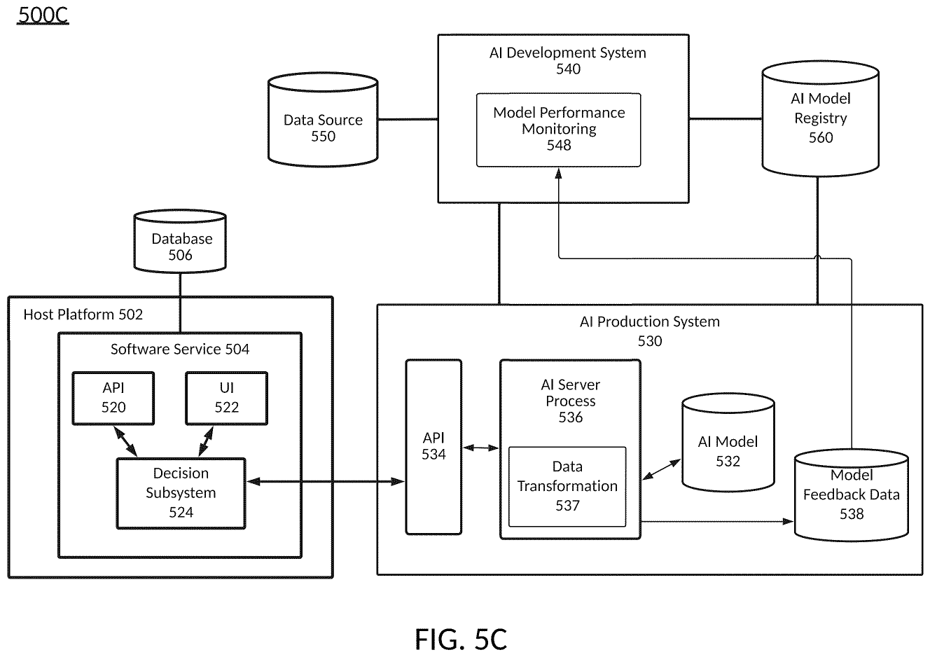

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies, and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI models refer to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content - such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks, and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results. The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art. An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer-implemented method comprising:
executing a plurality of machine learning (ML) models on questions to generate a plurality of outputs which include a plurality of chains of thought (COT), respectively;
generating a mapping between a plurality of different types of tasks and the plurality of ML models, respectively, based on the plurality of COT;
receiving a request to execute a predictive process that includes a plurality of sub-tasks;
executing a software as a service (SaaS) ML model on the plurality of sub-tasks and the mapping to identify a subset of ML models from among the plurality of ML models for performing the plurality of sub-tasks, respectively; and
generating machine-readable instructions which include a sequence among the subset of ML models for executing the plurality of sub-tasks.

2. The computer-implemented method of claim 1, further comprising executing the subset of ML models on input data associated with the predictive process based on the machine-readable instructions to generate a prediction, and displaying the prediction via a graphical user interface (GUI) of a software application.

3. The computer-implemented method of claim 2, wherein the executing the subset of ML models comprises executing a second ML model on an output of a first ML model, wherein the executing the second ML model comprises modifying the output of the first ML model based on a prompt template associated with model capabilities of the second ML model before executing the second ML model on the output.

4. The computer-implemented method of claim 1, wherein the generating the mapping comprises identifying an ML model from among the plurality of ML models that is best-suited for a respective type of task based on a chain of thought of the ML model and a ground truth associated with an output of the ML model.

5. The computer-implemented method of claim 1, wherein the generating the machine-readable instructions comprises generating a data flow among the subset of ML models for executing the plurality of sub-tasks.

6. The computer-implemented method of claim 1, wherein the generating comprises generating a plurality of nodes representing the subset of ML models, and edges between the plurality of nodes representing a flow of data between the subset of ML models.

7. The computer-implemented method of claim 1, wherein the SaaS ML model and the plurality of ML models comprise a mixture of experts (MOE) architecture in which the SaaS ML model is a starting point and the plurality of ML models are executed subsequently.

8. A computer system comprising:
a processor set;
a set of one or more computer-readable storage media; and
program instructions, collectively stored in the set of one or more storage media, that cause the processor set to perform computer operations comprising:
executing a plurality of machine learning (ML) models on questions to generate a plurality of outputs which include a plurality of chains of thought (COT), respectively;
generating a mapping between a plurality of different types of tasks and the plurality of ML models, respectively, based on the plurality of COT;
receiving a request to execute a predictive process that includes a plurality of sub-tasks;
executing a software as a service (SaaS) ML model on the plurality of sub-tasks and the mapping to identify a subset of ML models from among the plurality of ML models for performing the plurality of sub-tasks, respectively; and
generating machine-readable instructions which include a sequence among the subset of ML models for executing the plurality of sub-tasks.

9. The computer system of claim 8, wherein the computer operations further comprise executing the subset of ML models on input data associated with the predictive process based on the machine-readable instructions to generate a prediction, and displaying the prediction via a graphical user interface (GUI) of a software application.

10. The computer system of claim 9, wherein the executing the subset of ML models comprises executing a second ML model on an output of a first ML model, wherein the executing the second ML model comprises modifying the output of the first ML model based on a prompt template associated with model capabilities of the second ML model before executing the second ML model on the output.

11. The computer system of claim 8, wherein the generating the mapping comprises identifying an ML model from among the plurality of ML models that is best-suited for a respective task based on a chain of thought of the ML model and a ground truth associated with an output of the ML model.

12. The computer system of claim 8, wherein the generating the machine-readable instructions comprises generating a data flow among the subset of ML models for executing the plurality of sub-tasks.

13. The computer system of claim 8, wherein the generating comprises generating a plurality of nodes representing the subset of ML models, and edges between the plurality of nodes representing a flow of data between the subset of ML models.

14. The computer system of claim 8, wherein the SaaS ML model and the plurality of ML models comprise a mixture of experts (MOE) architecture in which the SaaS ML model is a starting point and the plurality of ML models are executed subsequently.

15. A computer program product comprising:
a set of one or more computer-readable storage media; and
program instructions, collectively stored in the set of one or more computer-readable storage media, for causing a processor set to perform computer operations comprising:
executing a plurality of machine learning (ML) models on questions to generate a plurality of outputs which include a plurality of chains of thought (COT), respectively;
generating a mapping between a plurality of different types of tasks and the plurality of ML models, respectively, based on the plurality of COT;
receiving a request to execute a predictive process that includes a plurality of sub-tasks;
executing a software as a service (SaaS) ML model on the plurality of sub-tasks and the mapping to identify a subset of ML models from among the plurality of ML models for performing the plurality of sub-tasks, respectively; and
generating machine-readable instructions which include a sequence among the subset of ML models for executing the plurality of sub-tasks.

16. The computer program product of claim 15, wherein the computer operations further comprise executing the subset of ML models on input data associated with the predictive process based on the machine-readable instructions to generate a prediction, and displaying the prediction via a graphical user interface (GUI) of a software application.

17. The computer program product of claim 16, wherein the executing the subset of ML models comprises executing a second ML model on an output of a first ML model, wherein the executing the second ML model comprises modifying the output of the first ML model based on a prompt template associated with model capabilities of the second ML model before executing the second ML model on the output.

18. The computer program product of claim 15, wherein the generating the mapping comprises identifying an ML model among the plurality of ML models that is best suited for performing a type of task from among the plurality of different types of tasks based on a chain of thought of the ML model.

19. The computer program product of claim 15, wherein the generating the machine-readable instructions comprises generating a data flow among the subset of ML models for executing the plurality of sub-tasks.

20. The computer program product of claim 15, wherein the generating comprises generating a plurality of nodes representing the subset of ML models, and edges between the plurality of nodes representing a flow of data between the subset of ML models.
